(19) United States
(12) Patent Application Publication
(10) Pub. No.: US 2026/0227967 A1
(43) Pub. Date: Aug. 6, 2026

(54) Agent Code Generation

(71) Applicant: Sierra Technologies, Inc., San Francisco, CA (US)

(72) Inventors: Karthik Rajagopal Narasimhan, Foster City, CA (US); Noah Ryan Shinn, San Francisco, CA (US); Joshua Roberts, San Francisco, CA (US); Victor Barres, San Francisco, CA (US)

(21) Appl. No.: 19/453,252

(22) Filed: Jan. 20, 2026

Related U.S. Application Data
(60) Provisional application No. 63/752,146, filed on Jan. 31, 2025.

(51) Int. Cl. G06F 8/35

(52) U.S. Cl. CPC G06F 8/35

(57) ABSTRACT

A system accesses a plurality of historical conversations. The system clusters the plurality of historical conversations into one or more categories using a large language model, where each category corresponds to a user intent and conversations clustered in a category are associated with the respective user intent of the category. The system generates, based on the user intent associated with each category, agent code for generating responses corresponding to the user intent of the respective category. The system applies the generated agent code to a new conversation to generate a response for the new conversation and updates the generated agent code based on feedback on the response.

### CROSS REFERENCE TO RELATED APPLICATION

This application claims the benefit of U.S. Provisional Application No. 63/752,146, filed Jan. 31, 2025, which is incorporated by reference.

### TECHNICAL FIELD

The disclosure generally relates to the field of artificial intelligence, and more specifically relates to using declarative syntax to operate a declarative agent using hierarchical components.

### BACKGROUND

Agents are software that coordinate sequences of interactions with AI (artificial intelligence), such as LLMs (large language models) and external software systems. In chat automation systems, LLMs are difficult to deploy because they are not deterministic. This limitation may result in inconsistent actions being taken and inconsistent messaging given similar prompts that should yield consistent messaging, and it may also result in hallucinations that provide inaccurate or dangerous information or improper actions.

Current chat automation systems often use pre-trained models to generate agent code that enables the chat agent. However, generating agent code using pre-trained models often suffers from a lack of domain-specific expertise and limited context awareness. These models are trained on broad datasets and may fail to incorporate the specialized knowledge or logic required for specific industries, resulting in code that does not fully meet the intended requirements. Additionally, they struggle with maintaining long-term conversation context, often generating incomplete or stateless solutions that require significant post-processing to be functional. The outputs are frequently not optimized, with redundant or inefficient code that demands manual cleanup, making the pre-trained models less suitable for high-performance or domain-critical applications.

### SUMMARY

Systems and methods are disclosed herein that provide guardrails for actions and utterances a LLM can take in a chat automation system. The guardrails ensure that outputs of an LLM match the intent of the entity deploying the chat automation system, all while enabling the flexibility of nuanced outputs of an LLM that improve upon the rigidity of a rules-based system.

In one aspect, this disclosure provides a method for generating agent code. The system accesses a plurality of historical conversations and uses a large language model to cluster the plurality of historical conversations into one or more categories. Each category corresponds to a user intent, and conversations clustered in a category are associated with the same respective user intent of the category. Based on the user intent associated with each category, the system generates agent code for generating responses corresponding to the user intent of the respective category. The system applies the generated agent code to a new conversation to generate a response for the new conversation, and updates the agent code based on feedback on the response.

By identifying user intent before generating agent code, the system ensures that the responses directly address the user's goals, reducing errors and creating meaningful interactions. This approach reduces misinterpretations and generates outputs that are precise and relevant to the specific context, ensuring the agent consistently delivers accurate results. Understanding user intent reduces error propagation and provides accurate interpretation of user input before the code generation process begins. The system includes robust error-handling mechanisms within the generated code so that it recovers from unexpected failures or edge cases. Additionally, understanding intent allows the agent to offer personalized solutions that consider user preferences, history, and context. This method also aligns generated code with broader system requirements so that it integrates into larger applications or workflows.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 illustrates one embodiment of a system environment for implementing a declarative agent service, in accordance with one or more embodiments.

FIG. 2 illustrates one embodiment of modules of the declarative agent service, in accordance with one or more embodiments.

FIG. 3 is a block diagram illustrating components of an example machine able to read instructions from a machine-readable medium and execute them in a processor (or controller), in accordance with one or more embodiments.

FIG. 4 is a flowchart of a method for updating generated agent code based on feedback on a response, in accordance with one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Figure (FIG.) 1 illustrates one embodiment of a system environment for implementing a declarative agent service. As depicted in FIG. 1, declarative agent service environment 100 includes client device 110. While policy enforcement application 111 is only depicted with respect to one client device 110, this is for convenience only, and many number of client devices may be interacting with declarative agent service 130. Client device 110 may be any device operated by an end-user having a user interface, such as a smartphone, a laptop, a personal computer, a wearable (e.g., smart watch), a kiosk, or any other electronic device capable of interfacing between a user and declarative agent service 130.

Declarative agent service 130 may be accessed by client device 110 using application 111. Application 111 may be an application dedicated to activities of declarative agent service 130 (e.g., an installed software package downloaded from declarative agent service 130 or an external repository such as an app store, or installed using other means such as a hard disk). Alternatively or additionally, application 111 may be a browser through which declarative agent service 130's functionality may be accessed (e.g., directly, or indirectly through an embedded portal in a website of third party company).

External software system 115 may be a software system of, e.g., a platform that utilizes declarative agent service 130. External software system 115 may require human intervention or may be utilized without a human in the loop, and may be configured to provide functionality, such as chatbot (interchangeably used with “chat automation system”) functionality to users of the platform. Client device 110 may be used by an entity controlling external software system 115 to communicate to declarative agent service 130 information sufficient to deploy guardrails on LLM outputs and/or may be used by end-users interacting with external software system 115 to resolve and otherwise chat through an issue.

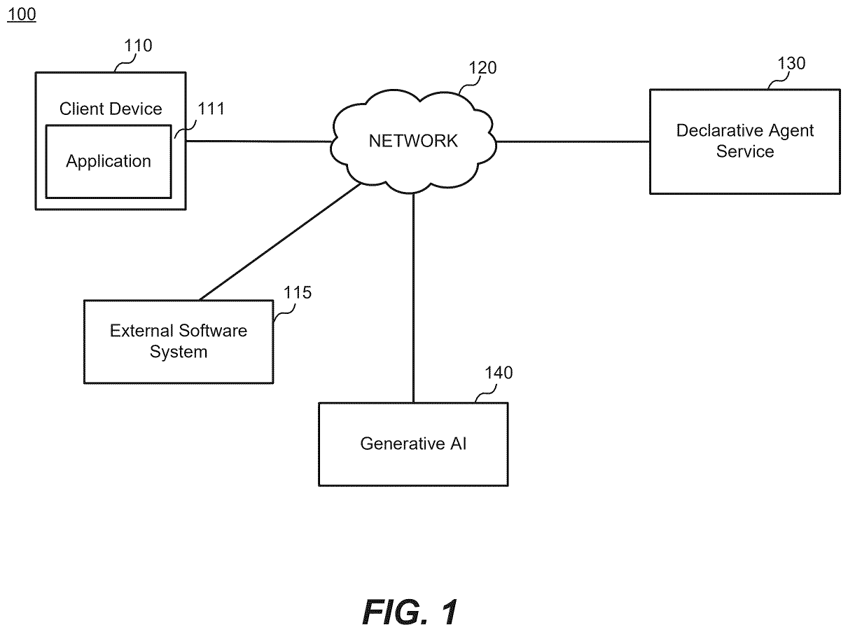

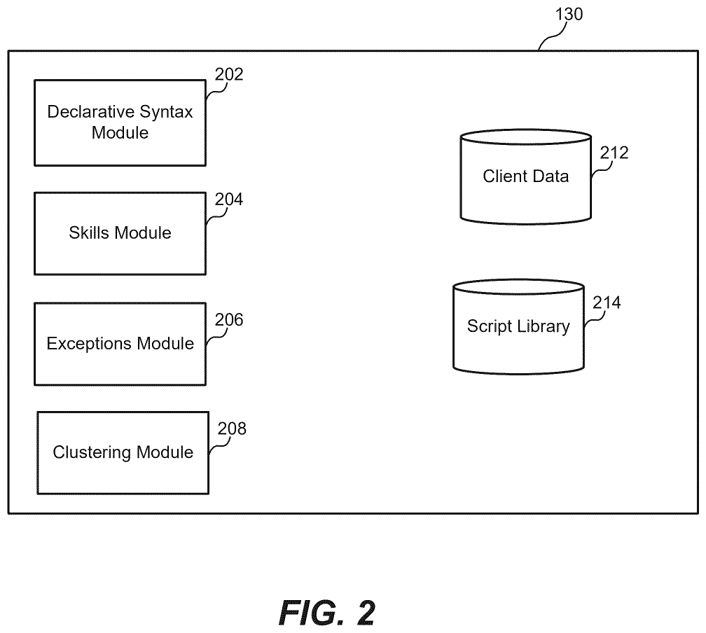

Declarative agent service 130 is used by client devices 110 and/or external software system 115 to provide a chat interface that addresses inquiries by users or by the platform of an external software system. Declarative agent service 130 is instantiated on one or more servers, accessible by way of network 120. Some or all functionality of declarative agent service 130 described herein may be distributed or fully performed by application 111 on a client device, or vice versa. Where reference is made herein to activity performed by application 111, it equally applies that declarative agent service 130 may perform that activity off of the client device, and vice versa. Declarative agent service 130 may be provided as a software development kit (SDK) to a client device or external software service to enable these entities to build the functionality of declarative agent service 130 on-premises. The SDK may export an API such that 3rd parties (e.g., client devices or external software services) can specify their agents. Agent code using the SDK API is then uploaded to declarative agent service 130, on which it can execute (and run as an agent). Further details about the operation of declarative agent service 130 are described below with reference to FIG. 2.

Generative AI 140 may be part of declarative agent service 130 or may be a third-party provider (e.g., OpenAI) that provides generative AI for processing natural language queries. Generative AI 140 may include one or many LLMs, the LLMs provided by any number of providers.

FIG. 2 illustrates one embodiment of modules of the policy enforcement service. As depicted in FIG. 2, declarative agent service 130 includes declarative syntax module 202, skills module 204, exceptions module 206, clustering module 208, client data 212, and script library 214. These modules and databases are merely illustrative; fewer or more modules and/or databases may be used to achieve the functionality disclosed herein.

Declarative syntax module 202 has syntax for specifying sub-modules of an agent's behavior. Script library 214 is a code library (e.g., a JavaScript library, though any code may be used) that specifies hierarchical components of an agent's behavior. As an example, script library 214 may be a JSX (JavaScript XML) library. Each component can be responsible for a distinct task, and can delegate to flexibly defined children components (lower in the hierarchy) for subsequent actions or behaviors. As a consequence of specifying behavior in components, we increase composability and reuse. The following code is an example of usage of declarative syntax:
function Agent( ) {
   return (<Triage>
      <Category description=“Return items”>
         <ReturnItems />
      </Category>
      <Category description=“Cancel order”>
         <CancelOrder />
      </Category>
   </Triage>);
}
function ReturnItems( ) {
   return (<>
      <Input fields={[‘orderNumber’, ‘email’]} onInput={getOrder}>
      {order && <Choose options={order.items} onChoose={chooseItems}/>}
      {items && <Choose options={returnMethod} onChoose{setReturnMethod}/>}
   {returnMethod && <ProcessReturn order={order} items={items}
returnMethod={returnMethod} />
   </>);
}

Skills form the primitive and foundational unit of an agent's behavior. Skills module 204 deploys skills as needed when interacting with an external system. These base skills are highly configurable and highly reusable, and the complete of them allow agents to do a wide variety of tasks.

In some embodiments, skills module 204 deploys a Triage skill. For example, where an agent is interacting in a chatbot capacity with a user of client device 110, given messages from the user and possible options, skills module 204 uses Triage to determine which category best matches the user's issue. When deploying Triage, skills module 204 prompts the user with clarifying questions and performs prioritization according to defined heuristics. Triage may be configured by an entity controlling external software system 115 to define categories that could match what an end-user is seeking assistance on, and children nodes that define one or more skills that are to be used to handle further conversation relating to a corresponding category. For example, “return shoes” may be defined as a category, “shipping status” may be defined as a category, and “cancel order” may be defined as a category. Triage may be configured to map LLM outputs based on end-user input to given categories.

The specification of an instance of Triage provides arbitrarily hierarchical groups of descriptions of types of issues a user may be interested to address. When a user sends a message, Triage generates a prompt to an LLM (e.g., generative AI 140) with the set of categories rendered to allow for incremental refinement through the hierarchical groups. Skills module 204 achieves this by keying each group with a new token in alternating numeric and alphabet characters, so that at each step in the token generation the LLM is narrowing in semantically into the user's intent.

For example, an agent specification as configured may have a group that contains descriptions of various types of returns (“return damaged item”, “return item purchased in-store”, “return item purchased online”, “return brand new item”). These descriptions allow the LLM to match a wide range of user messages reliably, and allow the agent to route them independently as well (e.g. an in-store purchase may need to be returned in-person). When a user sends a message such as “I'd like to return my shoes”, we send that along with the category descriptions to the LLM and give the opportunity for the LLM to ask clarifying questions. In this example, it would ask “Where did you purchase the item and are they in new condition?”. Responsive to the user clarifying the necessary details, the agent sends a subsequent call to the LLM which would select the correct category.

This is distinct from baseline techniques in that it allows Triage to fairly large total sets of classification categories as long as they are organized into semantic groupings that allow for incremental refinement. Examples of baseline techniques are 1) to provide the LLM with enumerated category options (labeled or numbered) or 2) do multiple LLM calls in succession, at each step drilling into more detail on the select category (like a nested menu).

Rather than use these baseline techniques, the triage skill leverages the auto-regressive nature of LLM token generation so that in each token that is generated, the possible options are reduced. For example, if a typical numbering scheme would be: 1) Return brand new item; 2) Return damaged item; 3) Return item purchased online; 4) Return item purchased elsewhere; 5) . . . ; 40) File a warranty claim, then the LLM would be required to pick between 40 next possible tokens when attempting to classify the intent (since numbers 1-40 are all 1 token). Whereas the Triage skill has an approach to label these such that each token helps incrementally refine the options, in a semantically related way. So for example: A1) Return brand new item; A2) Return damaged item; A3) Return item purchased online; A4) Return item purchased elsewhere; B1) . . . ; G1) File a warranty claim, etc. Now the number of tokens the LLM has to choose between is limited to A-G (e.g., root nodes), and if it were to choose A then the next possible tokens would be limited to 1-4 (e.g., child nodes). By deploying triage in this manner, both accuracy computational efficiency is dramatically improved, in that computing a match to candidate categories can be reduced by an order of magnitude or more while reducing noise that influences inaccuracies by first evaluating initial nodes and then evaluating child nodes.

Guardrails may be deployed when using the LLM to classify intent of an end-user. For example, while the term “return” will output an initial classification in category A, external software system 115 may be configured with a “dissatisfaction” guardrail, where when a user expresses dissatisfaction the user is directed to a certain outcome (e.g., a human representative or some other intervention). Where such a guardrail is deployed, “I am dissatisfied with the return process” may be categorized by the dissatisfaction guardrail despite it matching the Return category “A”.

In some embodiments, configuring guardrails and categories for skills used by external software system 115 may be assisted using machine learning. For example, after a configuration is set, declarative agent service 130 may apply the configuration and perhaps other auxiliary information to a supervised machine learning model, such as a convolutional neural network, a deep learning classifier, and so on. The machine learning model may output an identification of a gap in the categories and/or guardrails and/or recommendations for additional categories and/or guardrails. The machine learning model may be trained using training examples of configurations for similar purposes by other external software systems 115. In some embodiments, the training data may be labeled by additional categories and/or guardrails deployed after initial deployment, which may be indicative of gaps found following live use of the external software systems 115. The entity deploying the external software system 115 may select the recommendations to have them automatically added as additional categories and/or guardrails. Child nodes may be similarly recommended based on child skills indicated in the configuration data.

In some embodiments, declarative agent service 130 may generate agent code to respond to a user's input by leveraging historical conversations to understand user intents and automating the response generation process. In some implementations, the declarative agent service 130 may cluster the historical conversations based on user intents. The declarative agent service 130 may group similar user intents, identify patterns in the responses, and generate agent code that addresses these intents corresponding. In some embodiments, the declarative agent service 130 may use unsupervised learning techniques (such as clustering). In some embodiments, the declarative agent service 130 may use large language models (LLMs) to automate the clustering. Based on the intent of a conversation, the declarative agent service 130 determines how the agent of the declarative agent service 130 responds to a user in the corresponding conversation, and generates agent code that enables the agent.

User intents refer to the underlying goals or purposes behind the users'messages or actions. When a user interacts with the declarative agent service 130, they may have a request or query that drives their conversations. The intent may be what the user hopes to achieve through the interaction, for example, getting information, making a request, or seeking assistance. By accurately understanding these intents, the declarative agent service 130 may respond in ways that directly address the users'requests/queries, providing a more efficient and personalized experience. In some embodiments, the declarative agent service 130 may generate a hierarchy of intents to organize different types of queries/requests into structured categories. By grouping intents from general categories down to specific actions, the declarative agent service 130 may generate the agent code corresponding to the hierarchy, such as a decision tree, enabling more efficient handling of conversations and interactions.

In one implementation, at the top level, intents are broadly clustered into categories like Requests and Inquiries, Sales & Purchases, Feedback & Complaints, and the like. These broad categories are further divided into sub-categories that provide more specific groupings, such as Technical Support and Account Support under Requests and Inquiries. In some cases, each sub-category is broken down into specific intents, which represent the user action or need, such as a Refund Request or Tracking Number Inquiry.

In some embodiments, the declarative agent service 130 may include a clustering module 208 that clusters historical conversations into one or more categories. The declarative agent service 130 may access a database that stores a plurality of historical conversations, and the declarative agent service 130 applies a model to the historical conversations to determine their corresponding categories. In some embodiments, the database may be continuously and periodically updated with newly received conversations.

In one example, the model is a large language model (LLM), and the clustering module 208 inputs the historical conversations to the LLM and receives, for each conversation, at least one category which the respective conversation belongs to. In some embodiments, the clustering may start with some pre-defined categories, such as Request, Refund, etc.; alternatively, the clustering may start with zero pre-defined categories. For example, the clustering module 208 may generate a set of initial training samples. The initial training samples may be formed by randomly selected historical conversations. The clustering module 208 may use the initial training samples to determine a set of categories, and each category corresponds to a user intent. In one instance, the clustering module 208 may generate a prompt to the LLM that requests the LLM to output an intent of the conversation. In one example, the generated prompt may be like,
“The following conversation is between a customer and a customer service agent. Based on the conversation, please identify an intent of the customer
“Customer: I want to know when my refund will be processed.
Agent: Please provide your order number . . . .”

The clustering module 208 may receive an output from the LLM including a user intent for the conversation. For example, the user intent may be “Refund,” which is selected as an initial category to cluster conversations. Using the set of initial training samples, the clustering module 208 may determine a set of initial categories. The initial categories may include complaint, inquiry, feedback, refund request, technical support, etc. In some implementations, a human operator may review the initial set of categories and adjust the categories as needed.

Once the initial categories are established, the clustering module 208 may apply the LLM to the plurality of historical conversations and cluster to one or more categories based on the user intent associated with each conversation. The clustering module 208 may generate a prompt that includes a task description that describes the clustering, the set of categories, and the conversation to cluster. For instance, the prompt may describe each category briefly and then provide the conversation for clustering. The clustering task is then performed by inputting the prompt into the LLM. The LLM predicts the most relevant category based on its understanding of the input text and the provided options. In one instance, an example prompt may be,

Classify the following customer conversations into one of the intents below:
1. Inquiry: Asking for information about a product, service, or policy.
2. Feedback: Providing opinions or reviews about a product or service.
3. Refund Request: Asking for money back for a purchased product or service.
. . .
Examples:
“I need a refund because the product arrived damaged.”→Refund Request
“Can you tell me about your pricing for premium plans?”→Inquiry
“Great service! I'm very pleased with my experience.”→Feedback
. . .
Now classify the following conversation:
“I want to know when my refund will be processed.”

In some implementations, the clustering module 208 may allow the LLM to output new categories if none of the existing categories matches with the conversation. For example, the prompt may include “Please suggest a new category based on the user intent associated with the following conversation, if you consider none of the provided categories matches with the following conversation.” The clustering module 208 may shuffle the historical conversations and iteratively apply the LLM to the conversations to cluster the conversations. In some implementations, the clustering module 208 may finalize a set of categories when the set of categories are stabilized, e.g., no new category is suggested, the same conversation does not fall into two different categories, the clustering of conversations does not change significantly between different iterations, and the like. In some cases, the number of stabilized categories may be a large number, for example, over 10,000. The conversations may now be equally distributed among the categories. Some of the categories may include a large number of conversations, while some of the categories may only include a few number of conversations. In some embodiments, a human operator may determine a threshold for the number of conversations in a category and may combine/rearrange the categories with a number of conversations below the threshold. In some embodiments, the declarative agent service 130 may prioritize the agent code generation for categories with a large number of conversations.

Based on the determined categories, the declarative agent service 130 may identify the user intents. In some embodiments, the declarative agent service 130 may determine a hierarchical structure for the user intents corresponding to the hierarchical structure of the categories. In some embodiments, the skills module 204 may deploy the skills in the AgentSDK to generate code that enables the generation of the agent's responses to the user's input in a conversation. In one example, the skills module 204 may generate a set of agent code specific to a category of user intent. In some examples, the skills module 204 may generate a set of agent code that is applicable to all categories of user intents. The skills module 204 may determine a response logic based on the user intent, for example, the response logic may be information retrieving, workflow execution, escalation to human operator, etc. In some embodiments, the skills module 204 may generate a flowchart or decision tree to structure the response logic corresponding to the user intents. In some embodiments, the skills module 204 may use a rule-based approach, where each intent is associated with specific responses. The skills module 204 may generate the agent code based on the determined response logic, and deploy the corresponding AgentSDK to generate the responses. In some embodiments, the generated agent code may be stored in a data store (e.g., script library 214) with the associated user intent/category.

The declarative agent service 130 applies the generated agent code in real conversations to evaluate and update the agent code. For instance, the declarative agent service 130 may receive a new conversation/user input. The declarative agent service 130 may apply the LLM to the user input and identify a category of the user input based on the user intent associated with user input. Based on the determined category, the declarative agent service 130 may deploy the agent code corresponding to the determined category and generate agent response to the user input.

The declarative agent service 130 may monitor the outcome of the conversation and/or technical performance metrics, such as response time, error rate, throughput, etc., to evaluate the response in order to evaluate the agent code and/or the categories. The declarative agent service 130 may continuously evaluate the agent code performance based on user review/feedback. For example, the declarative agent service 130 may integrate feedback options into a user interface, such as a quick survey after a conversation ends or a simple thumbs-up/thumbs-down rating system. The declarative agent service 130 may review feedback to identify common themes or issues. For example, if multiple users indicate that the agents'responses felt misleading or unhelpful, this may signal a need to adjust the tone or improve the response quality.

In some embodiments, the declarative agent service 130 may implement a feedback loop for retaining/updating the agent code. For example, the declarative agent service 130 may add new categories to identify new user intents. The declarative agent service 130 may update the underlying algorithms and machine learning models to improve accuracy, efficiency, and scalability, including refining NLP models, enhancing sentiment analysis, or optimizing dialogue management. In some embodiments, the declarative agent service 130 may include a human-in-the-loop implementation, where human operators may periodically review the agents of the declarative agent service 130 conversations to ensure quality and provide additional annotations or corrections.

### Computing Machine Architecture

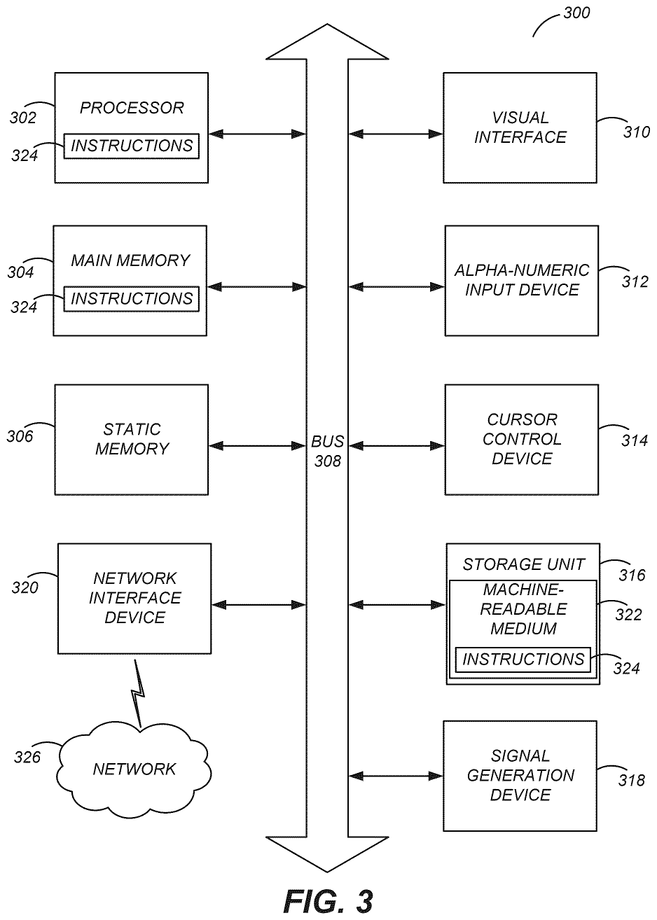

FIG. (Figure) 3 is a block diagram illustrating components of an example machine able to read instructions from a machine-readable medium and execute them in a processor (or controller). Specifically, FIG. 3 shows a diagrammatic representation of a machine in the example form of a computer system 300 within which program code (e.g., software) for causing the machine to perform any one or more of the methodologies discussed herein may be executed. The program code may be comprised of instructions 324 executable by one or more processors 302. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 324 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 300 includes a processor 302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include visual display interface 310. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 310 may include or may interface with a touch enabled screen. The computer system 300 may also include alphanumeric input device 312 (e.g., a keyboard or touch screen keyboard), a cursor control device 314 (e.g., a mouse, a trackball, a joystick, a motion sensor, or other pointing instrument), a storage unit 316, a signal generation device 318 (e.g., a speaker), and a network interface device 320, which also are configured to communicate via the bus 308.

The storage unit 316 includes a machine-readable medium 322 on which is stored instructions 324 (e.g., software) embodying any one or more of the methodologies or functions described herein. The instructions 324 (e.g., software) may also reside, completely or at least partially, within the main memory 304 or within the processor 302 (e.g., within a processor's cache memory) during execution thereof by the computer system 300, the main memory 304 and the processor 302 also constituting machine-readable media. The instructions 324 (e.g., software) may be transmitted or received over a network 326 via the network interface device 320.

While machine-readable medium 322 is shown in an example embodiment to be a single medium, the term “machine-readable medium” should be taken to include a single medium or multiple media (e.g., a centralized or distributed database, or associated caches and servers) able to store instructions (e.g., instructions 324). The term “machine-readable medium” shall also be taken to include any medium that is capable of storing instructions (e.g., instructions 324) for execution by the machine and that cause the machine to perform any one or more of the methodologies disclosed herein. The term “machine-readable medium” includes, but not be limited to, data repositories in the form of solid-state memories, optical media, and magnetic media.

### Example Method

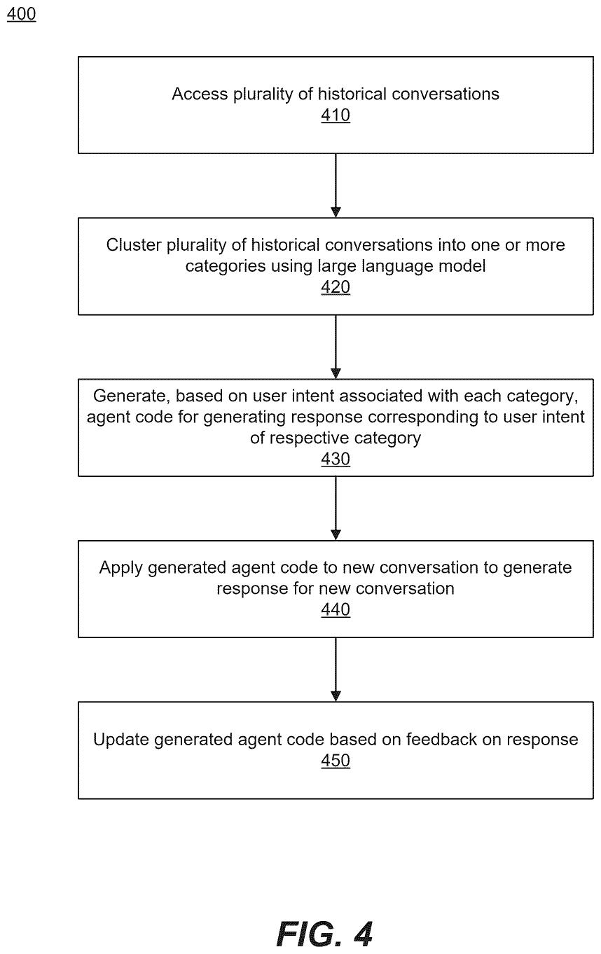

FIG. 4 is a flowchart of a method 400 for updating generated agent code based on feedback on a response, in accordance with one or more embodiments. In some embodiments, additional or alternative steps to those described in relation to FIG. 4 may be performed by the declarative agent service 130. Further, additional or alternative components to those described in relation to FIG. 4 may be used to perform the method.

The method 400 begins with accessing 410 a plurality of historical conversations. The declarative agent service 130 clusters 420 the plurality of historical conversations into one or more categories using a large language model. Each category corresponds to a user intent, and conversations clustered in a category are associated with the respective user intent of the category. In some embodiments, the one or more categories correspond to a hierarchy of intents, where categories at a lowest level of the hierarchy are each associated with a specific action. In some embodiments, the large language model is configured to output a new category in response to determining that one of the plurality of historical conversations does not match any of the one or more categories. The declarative agent service 130 generates 430, based on the user intent associated with each category, agent code for generating responses corresponding to the user intent of the respective category and applies 440 the generated agent code to a new conversation to generate a response for the new conversation. The declarative agent service 130 updates 450 the generated agent code based on feedback on the response. In some embodiments, updating the generated agent code based on feedback on the response comprises causing the generated agent code to, when executed, integrate one or more feedback options into a user interface.

In some embodiments, the method 400 includes generating a set of training examples from a set of randomly selected historical conversations and determining the one or more categories from the set of randomly selected historical conversations. In some embodiments, the method 400 includes providing the one or more categories for display in a user interface, where the user interface is configured to receive interactions indicative of adjustments to the one or more categories. In some embodiments, the method 400 includes reclustering historical conversations of a subset of clusters using the large language model in response to determining, for each of the subset of clusters, that a number of historical conversations associated with the respective cluster is outside of a threshold.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
accessing a plurality of historical conversations;
clustering, using a large language model, the plurality of historical conversations into one or more categories, each category corresponding to a user intent, wherein conversations clustered in a category are associated with the respective user intent of the category;
generating, based on the user intent associated with each category, agent code for generating responses corresponding to the user intent of the respective category;
applying the generated agent code to a new conversation to generate a response for the new conversation; and
updating the generated agent code based on feedback on the response.

2. The method of claim 1, wherein the one or more categories correspond to a hierarchy of intents, wherein categories at a lowest level of the hierarchy are each associated with a specific action.

3. The method of claim 1, further comprising:
generating a set of training examples from a set of randomly selected historical conversations; and
determining the one or more categories from the set of randomly selected historical conversations.

4. The method of claim 1, further comprising:
providing, for display in a user interface, the one or more categories, wherein the user interface is configured to receive interactions indicative of adjustments to the one or more categories.

5. The method of claim 1, wherein the large language model is configured to output a new category in response to determining that one of the plurality of historical conversations does not match any of the one or more categories.

6. The method of claim 1, further comprising:
in response to determining, for each of a subset of clusters, that a number of historical conversations associated with the respective cluster being outside of a threshold, reclustering the historical conversations of the subset of clusters using the large language model.

7. The method of claim 1, wherein updating the generated agent code based on feedback on the response comprises causing the generated agent code to, when executed, integrate one or more feedback options into a user interface.

8. A non-transitory computer-readable storage medium storing instructions that, when executed, cause a processor to perform steps comprising:
accessing a plurality of historical conversations;
clustering, using a large language model, the plurality of historical conversations into one or more categories, each category corresponding to a user intent, wherein conversations clustered in a category are associated with the respective user intent of the category;
generating, based on the user intent associated with each category, agent code for generating responses corresponding to the user intent of the respective category;
applying the generated agent code to a new conversation to generate a response for the new conversation; and
updating the generated agent code based on feedback on the response.

9. The non-transitory computer-readable storage medium of claim 8, wherein the one or more categories correspond to a hierarchy of intents, wherein categories at a lowest level of the hierarchy are each associated with a specific action.

10. The non-transitory computer-readable storage medium of claim 8, the steps further comprising:
generating a set of training examples from a set of randomly selected historical conversations; and
determining the one or more categories from the set of randomly selected historical conversations.

11. The non-transitory computer-readable storage medium of claim 8, the steps further comprising:
providing, for display in a user interface, the one or more categories, wherein the user interface is configured to receive interactions indicative of adjustments to the one or more categories.

12. The non-transitory computer-readable storage medium of claim 8, wherein the large language model is configured to output a new category in response to determining that one of the plurality of historical conversations does not match any of the one or more categories.

13. The non-transitory computer-readable storage medium of claim 8, the steps further comprising:
in response to determining, for each of a subset of clusters, that a number of historical conversations associated with the respective cluster being outside of a threshold, reclustering the historical conversations of the subset of clusters using the large language model.

14. The non-transitory computer-readable storage medium of claim 8, wherein updating the generated agent code based on feedback on the response comprises causing the generated agent code to, when executed, integrate one or more feedback options into a user interface.

15. A system comprising:
a processor; and
a non-transitory computer-readable storage medium storing instructions that, when executed, cause the processor to perform steps comprising:
accessing a plurality of historical conversations;
clustering, using a large language model, the plurality of historical conversations into one or more categories, each category corresponding to a user intent, wherein conversations clustered in a category are associated with the respective user intent of the category;
generating, based on the user intent associated with each category, agent code for generating responses corresponding to the user intent of the respective category;
applying the generated agent code to a new conversation to generate a response for the new conversation; and
updating the generated agent code based on feedback on the response.

16. The system of claim 15, wherein the one or more categories correspond to a hierarchy of intents, wherein categories at a lowest level of the hierarchy are each associated with a specific action.

17. The system of claim 15, the steps further comprising:
generating a set of training examples from a set of randomly selected historical conversations; and
determining the one or more categories from the set of randomly selected historical conversations.

18. The system of claim 15, the steps further comprising:
providing, for display in a user interface, the one or more categories, wherein the user interface is configured to receive interactions indicative of adjustments to the one or more categories.

19. The non-transitory computer-readable storage medium of claim 8, wherein the large language model is configured to output a new category in response to determining that one of the plurality of historical conversations does not match any of the one or more categories.

20. The system of claim 15, the steps further comprising:
in response to determining, for each of a subset of clusters, that a number of historical conversations associated with the respective cluster being outside of a threshold, reclustering the historical conversations of the subset of clusters using the large language model.
